(19) United States
(12) Patent Application Publication
(10) Pub. No.: US 2007/0219727 A1
(43) Pub. Date: Sep. 20, 2007

(54) Cross-species comparative genomic hybridization visualization

(76) Inventors: Stephanie Fulmer-Smentek, Cupertino, CA (US); Peter G. Webb, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/378,661

(22) Filed: Mar. 17, 2006

(51) Int. Cl. G06F 19/00

(52) U.S. Cl. 702/20

(57) ABSTRACT

Comparative genomic hybridization is a tool that compares DNA samples from suspect cells of an organism with DNA samples from normal cells. Cross-species comparative genomic hybridization visualization allows genomic data from model organisms to be mapped and presented in accordance with the (for example) human genome to suggest possible common biological effects between two or more species.

### BACKGROUND

Comparative Genomic Hybridization (CGH) is a tool that compares DNA samples from suspect cells of an organism with DNA samples from normal cells. In particular, CGH determines when segments of the genome comprised by the cell are missing or “amplified” (e.g., duplicated), or are present in normal amounts. In healthy cells, there are normally two copies of each chromosome. (Sex-related chromosomes normally have either one or two copies depending upon the sex of the donor organism).

Tumorous cells often have segments of the genome that are missing, or perhaps that have been amplified. In such cases, the copy counts of genes are different from the copy numbers of genes from healthy cells. Additionally, genes from certain cancer types often have distinctive patterns in the copy number changes when compared with the copy numbers of genes from healthy cells. Accordingly, CGH is used to determine which parts of the genome have been affected by copy number changes. This background information is not intended to identify problems that must be addressed by the claimed subject matter.

### SUMMARY

This summary is provided to introduce a selection of concepts in a simplified form that are further described below in the Detail Description Section. This summary is not intended to identify key features or essential features of the claimed subject matter, nor is it intended to be used as an aid in determining the scope of the claimed subject matter.

According to aspects of various described embodiments, implementations are provided for comparing DNA samples from suspect cells of an organism with DNA samples from normal cells. Cross-species comparative genomic hybridization visualization allows genomic data from model organisms to be mapped and presented in accordance with the (for example) human genome to suggest possible common biological effects between two or more species.

In one aspect, a sequence of genetic information is received that is ordered in accordance with a first determined sequence of genetic material for a first species. An input command is received from a user for requesting a cross-species arrangement of data, and the received genetic information is mapped in accordance with a second determined sequence of genetic material for a second species in response. The mapped genetic information is output in accordance with the determined sequence of genetic material for the second species.

Embodiments may be implemented as a computer process, a computer system (including mobile handheld computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates an exemplary display for visualization of a cross-species comparative genomic hybridization system 100, according to one embodiment.

FIG. 2 illustrates a genome overview panel 110 for cross-species comparative genomic hybridization, according to one embodiment.

FIG. 3 illustrates chromosome overview panel 120 for visualization of cross-species comparative genomic hybridization, according to one embodiment.

FIG. 4 illustrates gene view panel 130 for visualization of cross-species comparative genomic hybridization, according to one embodiment.

FIG. 5 illustrates table 140 for visualization of cross-species comparative genomic hybridization, according to one embodiment.

FIG. 6 illustrates a system for visualization of cross-species comparative genomic hybridization, according to one embodiment.

FIG. 7 illustrates an operational flow 700 for cross-species comparative genomic hybridization visualization, according to one embodiment.

FIG. 8 illustrates a general computer environment 800, which can be used to implement the techniques described herein.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Model organisms are commonly studied as surrogates for understanding human disease. Viewing of data from chromosomes of the studied organisms (such as mice) is visualized for researchers by using array comparative genomic hybridization (CGH) techniques. The data are presented in accordance with the genomic view of the organisms studied.

Cross-species comparative genomic hybridization visualization allows genomic data from model organisms to be mapped and presented in accordance with the human genome. In particular, cross species CGH allows a researcher to find deletions or amplifications of sets of contiguous genes and model organisms that are also “conserved” in the human genome. Genes that are conserved have contiguous (or partially contiguous) sequences of bases such that a common biological origin is suggested between genomes. The conserved genes may lie either on a single chromosome (as in the model organism) or be distributed across several chromosomes.

The deletions or amplifications of sets of such comparable contiguous genes sets between the model organisms and humans signify a greater likelihood of common biological effects between the two species. The common biological effects are used to suggest possible treatment modalities for genetic diseases.

In an example human CGH process, around 40,000 probes are used for the micro-array data. The probes are generally uniformly distributed over the genome (at 5 kilobase intervals, for example), although the probes locations are biased towards the genes so that the resulting data correspond to deletions and copy number amplifications for particular genes. Accordingly, the micro-array data derived from the probes correspond to genetic conditions of the cell.

Exemplary System for Cross-Species Comparative Genomic Hybridization

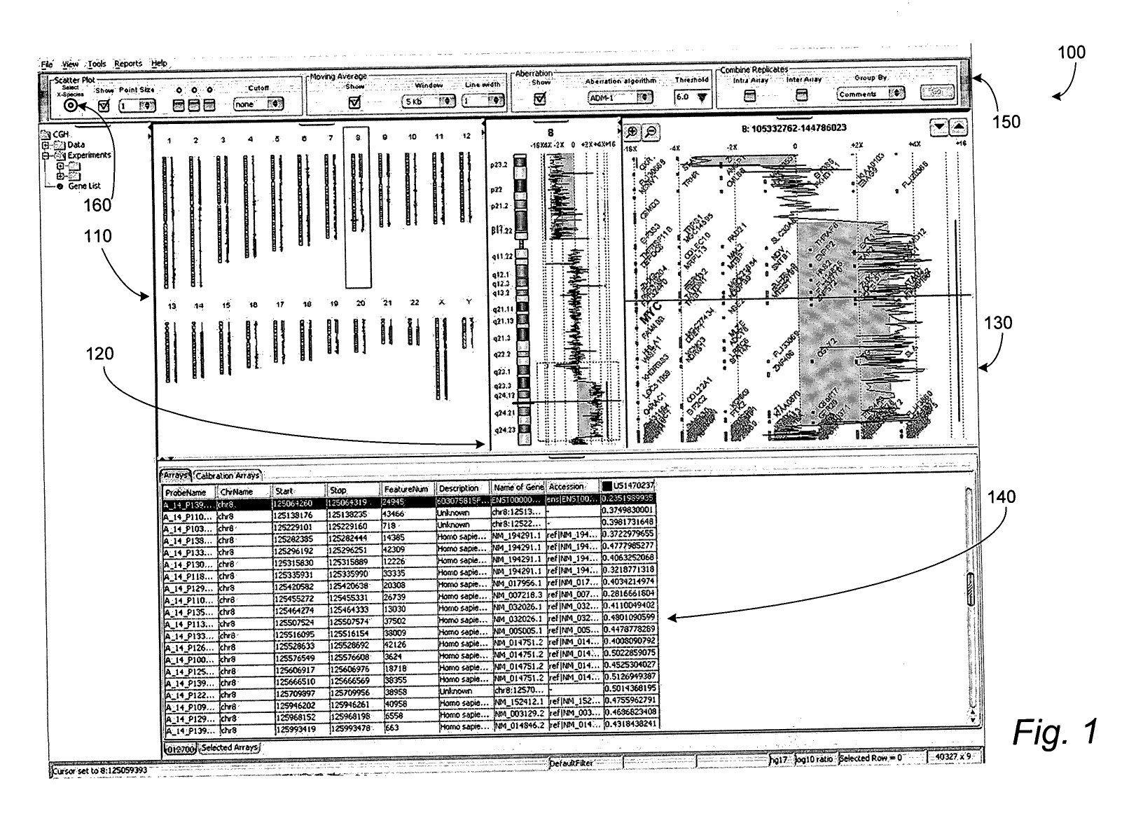

FIG. 1 illustrates an exemplary display for visualization of a cross-species comparative genomic hybridization system, according to one embodiment. In one embodiment, the system is implemented on a computer system having a user interface 100 has shown in the Figure. Interface 100 comprises genome overview panel 110, chromosome view 120, gene view panel 130, and table view panel 140.

Generally, each successive panel provides a more detailed view of the previous panel. Thus, areas (or items) selected in a window are shown in greater detail in the successive windows. Toolbar 150 (also comprised by interface 100) provides controls for selecting parameters used to control display of the data within the panels.

Button 160 allows a user to select a cross-species display of data. For example, a user optionally selects data from the mouse genome. The cross-species display of data transforms data (that are originally encoded with the mouse chromosomal locations) to human chromosomal locations. In so doing, each mouse gene location is associated with the gene locations on the given human chromosomes based on the mapping derived from the “conserved synteny” between the model organisms and human genome.

In an embodiment, alternately selecting button 160 allows users to view the data as mouse data (in accordance with mouse chromosomes) or to toggle the view such that the (mouse) data are arranged and displayed in accordance with the human ideogram. The genes are mapped in accordance with the conserved synteny between the model organisms and human. For example, data from a mouse GCH array are displayed as if it were data from a human GCH array.

In an alternative embodiment, data is mapped by using mapping data presented using additional data columns that includes the human chromosomal location in an input file. The inclusion of data from the additional columns allows for more varied organisms to be included in accordance with the included mapping information. Data from two or more various organisms are optionally presented in a side-by-side manner to facilitate visual comparisons by a user.

For example, data from a mouse GCH array, a rat GCH array, and a human GCH array are arranged in three side-by-side columns. Comparing the data (selected and/or highlighted by using thresholds such as degree of synteny and gene amplifications/deletions) can help a researcher to select whether rats or mice would be better studied

The degree of conserved synteny varies over a range from vaguely similar (e.g., genes that are distributed across multiple chromosomes) to substantially identical (e.g., genes that are not only present on the same chromosome, but are present in the same order on the chromosome). High degrees of conserved synteny typically suggest high correlations of common biological effects between the two species.

The degree of conserved synteny in the cross species display is optionally shown, for example, using color. For example, the color red can be used to show data with the highest degree of conserved synteny, while the color black to be used to show data for which no degree of conserved synteny has been determined. Accordingly, the use of color aids the researcher in locating areas within the chromosome having substantially higher possibilities of common biological effects between the two species.

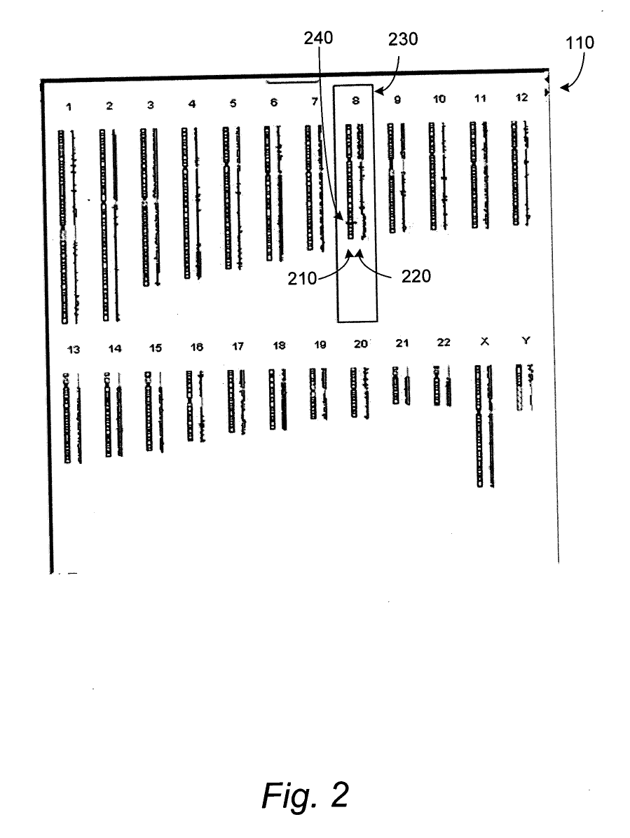

FIG. 2 illustrates genome overview panel 110 for visualization of cross-species comparative genomic hybridization, according to one embodiment. Genome overview panel 110 (comprised by interface 100) illustrates the ideogram of the entire genome of an organism. The entire genome comprises chromosomes that are designated with individual numbers or letters. In the (human) example, non sex-related chromosomes are numbered with the numbers 1-22, and the sex-related chromosomes are designated as X and Y. Each chromosome is represented by an ideogram 210 and a top-level view 220 of data (e.g., a plot of copy number changes) that are associated with the chromosome.

Selection of a particular chromosome (e.g., by clicking on the ideogram or associated data) is indicated by box 230. The example shows that chromosome number 8 has been selected. Indicator 240 shows a top-level view of the region on the chromosome that that is being viewed (or selected) in chromosome view panel 120.

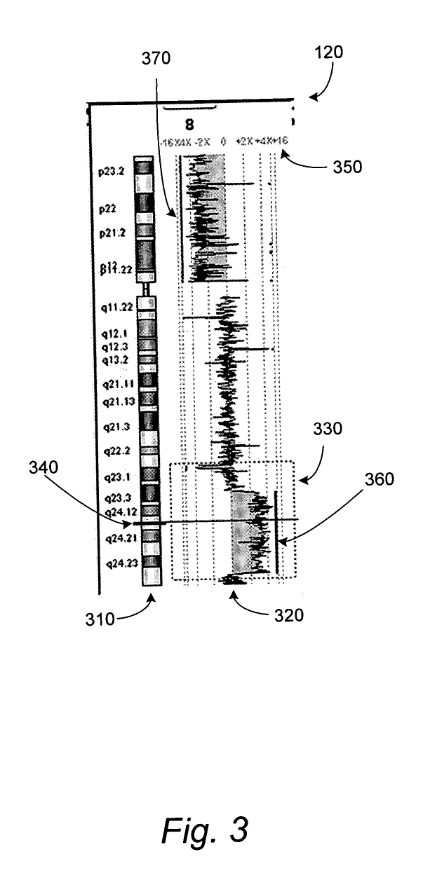

FIG. 3 illustrates chromosome overview panel 120 for visualization of cross-species comparative genomic hybridization, according to one embodiment. Chromosome overview panel 120 (comprised by interface 100) illustrates a “zoomed in” view on chromosome 8 (as depicted by ideogram 310). Data 320 represent a measurement of how many copies of genes were measured using various probe points of chromosome 8.

The example shows selection 330 around data related to the lower end of the “q” arm of the chromosome. Scale 350 (optionally shown in logarithmic form) shows relative presence of samples by factors of two. Data 320 is depicted as a “scatter plot” centered about a vertical axis located at the value zero. The scatter plot shows deletions of the genes to the left of the zero axis and amplifications of the genes to the right of the axis. The data are typically filtered (using boxcar averaging, for example) and a selected threshold (that is selected by a user, for example) to highlight significant amounts of deletions or amplifications. In various embodiments, sophisticated filters are used, for example, to determine if statistically significant data lie within apparent noise present in the data.

Data related to the lower end of the “q” arm of the chromosome in the example show significant amplification of genes that exceeds a selected threshold. In response to data exceeding the selected threshold, indicator bar 360 shows a segment of the chromosome that has amplifications of around four times. (Accordingly, the example data tend to indicate a doubling of the indicated segment.)

In the “p” arm of the chromosome, indicator bar shows a segment of the chromosome having around half of the gene copies that are present in a normal gene. (Accordingly, the example data tend to indicate a relative loss of the indicated segment.)

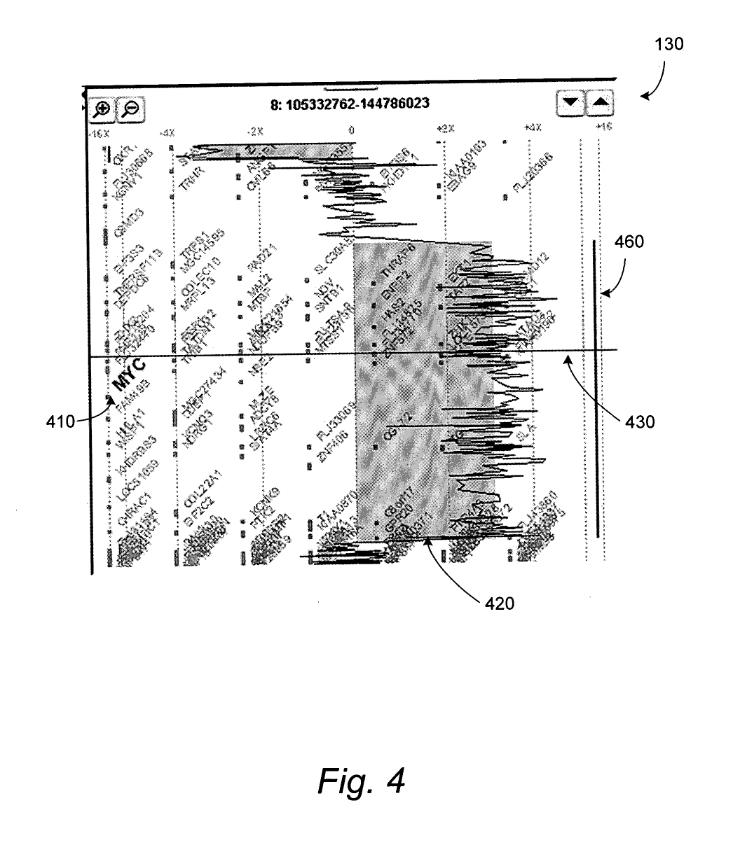

FIG. 4 illustrates gene view panel 130 for visualization of cross-species comparative genomic hybridization, according to one embodiment. Gene view panel 130 (comprised by interface 100) illustrates the example area shown by selection 330 in chromosome overview panel 220.

Gene view panel 130 shows “MYC” gene 410, which is often implicated in certain types of cancer. Indicator bar 460 indicates data that have exceeded a selected threshold. Shaded box 420 indicates, for example, an averaged value for the selected data. (The example data represent a threefold increase in the copy number count, which suggests a gene triplicate of the genes that lie on a particular pod of chromosome 8.) Line 430 is a reticule for selecting a particular probe point of a selected gene. The raw data that are associated with the selected probe point is typically represented in table 140.

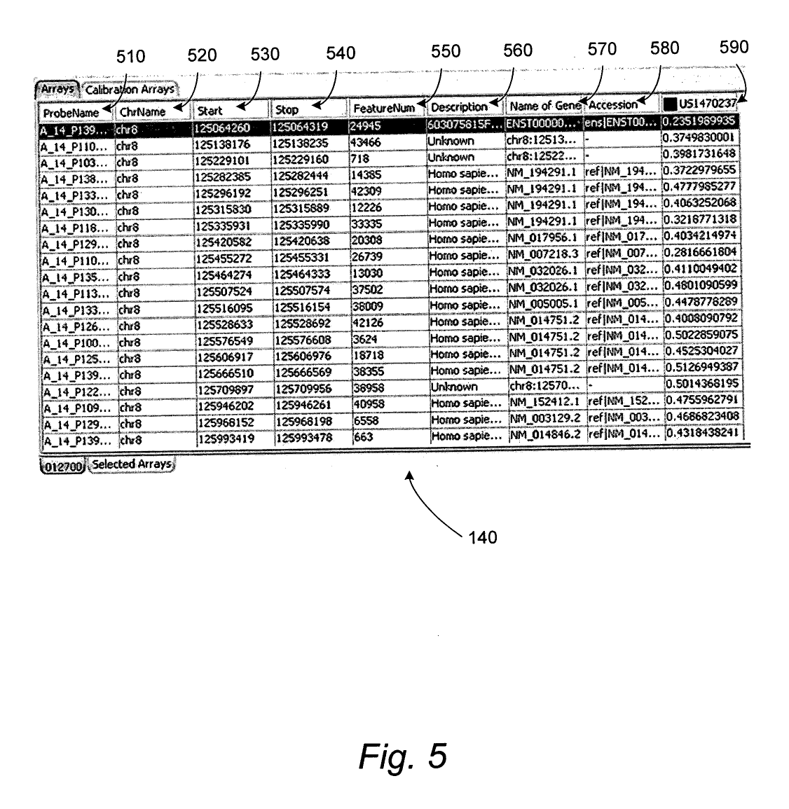

FIG. 5 illustrates table 140 for visualization of cross-species comparative genomic hybridization, according to one embodiment. Table 140 (comprised by interface 100) illustrates the raw data that is associated with a selected probe point shown in gene view panel 130. The first row of table 140 is highlighted and, for example, corresponds to the location of line 430 in gene view panel 130.

Column 510 of table 140 displays each name of the displayed probes. Column 520 indicates the name of the chromosome in which the probe lies. Columns 530 and 540 show the sequential address numbers of the base nucleotides at which the oligonucleotide associated with the probe resides.

Column 550 is a feature number having “local” significance to the researcher, such as a user-defined value. Column 560 contains a description for the genome of an organism or source with which the gene is associated. Column 570 contains a name of the gene. The name of the gene is universally assigned or referenced by a starting or stopping address the base nucleotides of the gene. Column 580 shows an accession number for indicating a number for referencing the particular gene in a gene sequence database. Column 590 contains values that are generated in response to the copy number changes associated with the gene. For example, the data shown represent a value determined by a logarithmic function of the copy number changes.

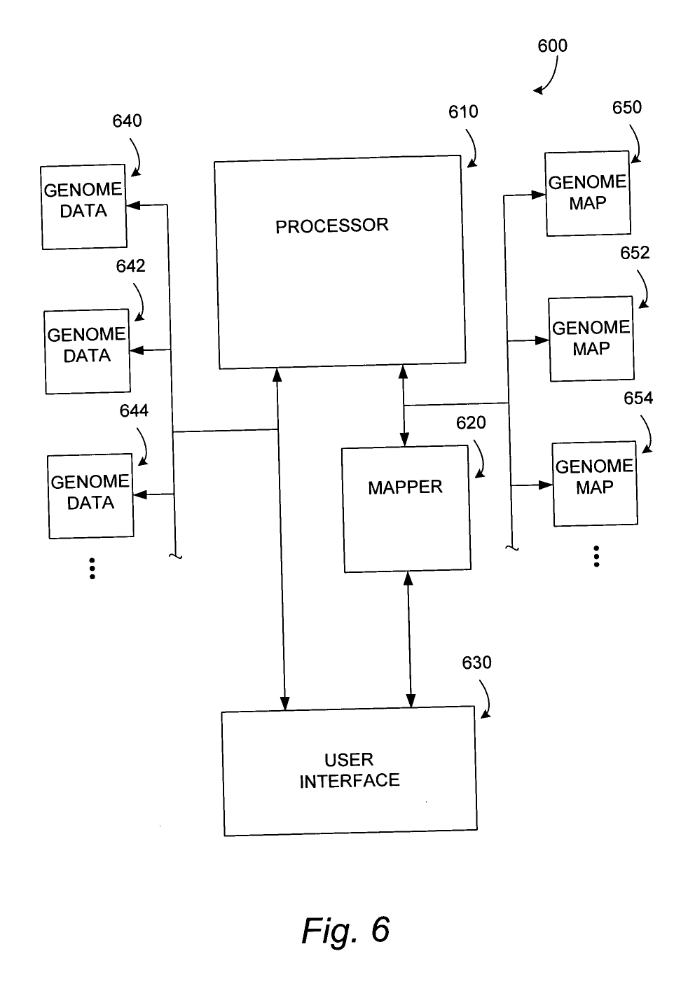

FIG. 6 illustrates a system for visualization of cross-species comparative genomic hybridization, according to one embodiment. System 600 comprises processor 610, mapper 620, user interface 630, genome data 640, 642, 644, and genome maps 650, 652, 654.

In one embodiment, processor 610 is configured to receive a sequence of genetic information that is ordered in accordance with a first determined sequence of genetic material for a first species. As described above, the genetic information can be from a human sample. Processor 610 communicates with user interface 630 to receive commands from a researcher who requests a cross-species arrangement of data.

The cross-species arrangement of data allows the researcher to see the data from the human sample in a different order. The researcher can use the user interface to receive commands that direct mapper 620 to arrange data as if the data were derived from a surrogate test subject (of a different species). For example, genome data 640, 642, 644 represent a human, mouse, and rat genome data respectively. Genome maps 650, 652, 654 are associated with human, mouse, and rat genomic information respectively and comprise sequence information used to map gene locations to a reference model (which may be human). If the reference model is human, genome map 650 may be omitted. Accordingly data from any particular test subject from one species can be mapped in accordance with any other species sequence information.

Exemplary Flow for Cross-Species Comparative Genomic Hybridization

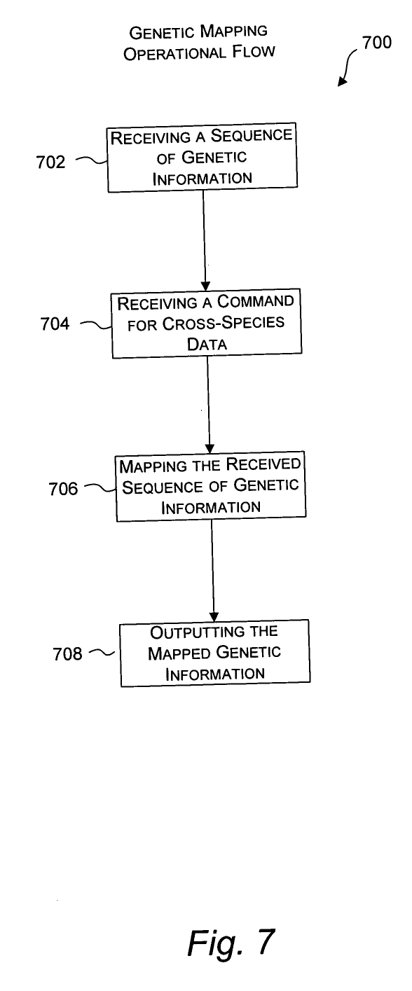

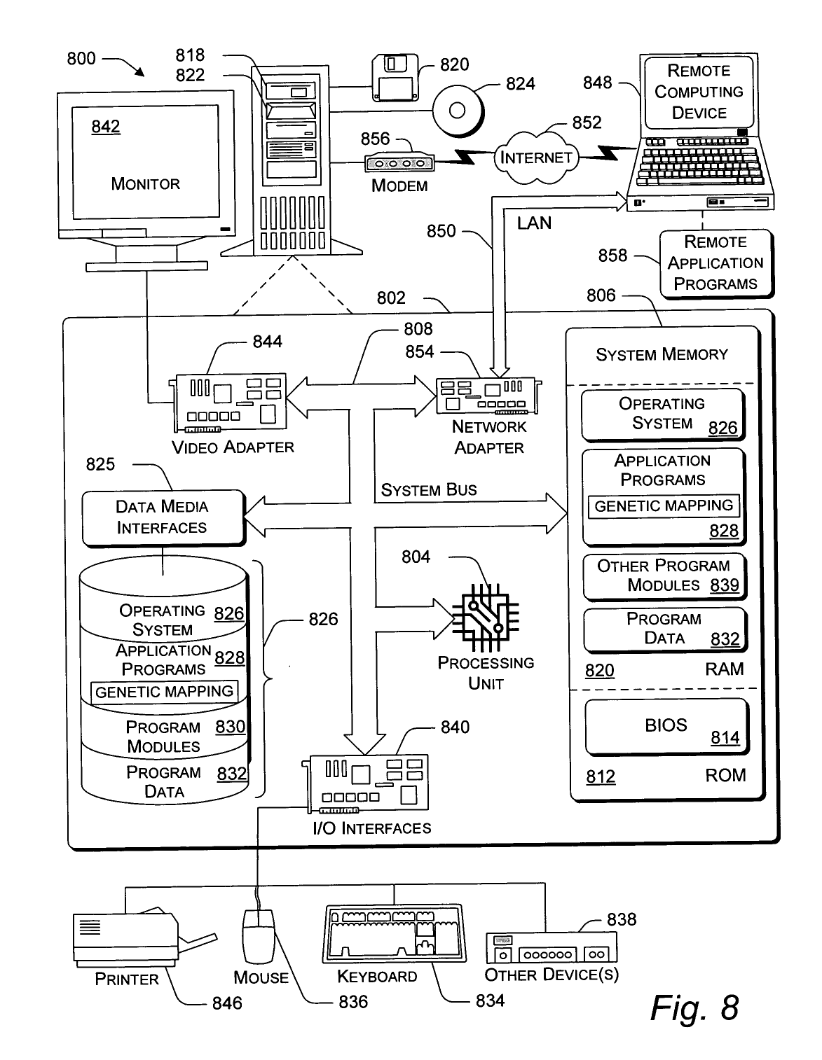

FIG. 7 illustrates an operational flow 700 for cross-species comparative genomic hybridization visualization, according to one embodiment. Operational flow 700 may be performed in any suitable computing environment. For example, operational flow 700 may be executed by an application such as application programs 828 (FIG. 8, below) to perform the cross-species comparative genomic hybridization visualization. Therefore, the description of operational flow 700 may refer to at least one of the components of FIG. 8. However, any such reference to components of FIG. 8 is for descriptive purposes only, and it is to be understood that the implementations of FIG. 8 is a non-limiting environment for operational flow 700.

At block 702, an application receives a sequence of genetic information that is ordered in accordance with a first determined sequence of genetic material for a first species. In one example, the sequence of genetic information is related to human genetic information from derived from gene probed genetic samples.

At block 704, an input command is received from a user for requesting a cross-species arrangement of data. In an embodiment, a user selects a genome from which to obtain gene sequence information to compare against the human genetic information.

At block 706, the received genetic information is mapped in accordance with a determined sequence of genetic material for the selected genome in response to the input command. Possible embodiments include mapping genetic information that is from a third species in accordance with other genomic sequences.

At block 708, the mapped genetic information is output in accordance the determined sequence of genetic material for the second species. This, for example, allows the user to view genetic information from a test subject as if it came from a second species (which may provide suitable test subjects). To aid the user, other embodiments allow the user to specify thresholds (such as numbers of gene copies) to highlight potential areas for research and to arrange the data in response to degrees of conserved synteny.

Illustrative Operating Environment

FIG. 8 illustrates a general computer environment 800, which can be used to implement the techniques described herein. The computer environment 800 is only one example of a computing environment and is not intended to suggest any limitation as to the scope of use or functionality of the computer and network architectures. Neither should the computer environment 800 be interpreted as having any dependency or requirement relating to any one or combination of components illustrated in the example computer environment 800.

Computer environment 800 includes a general-purpose computing device in the form of a computer 802. The components of computer 802 can include, but are not limited to, one or more processors or processing units 804, system memory 806, and system bus 808 that couples various system components including processor 804 to system memory 806.

System bus 808 represents one or more of any of several types of bus structures, including a memory bus or memory controller, a peripheral bus, an accelerated graphics port, and a processor or local bus using any of a variety of bus architectures. By way of example, such architectures can include a Peripheral Component Interconnects (PCI) bus also known as a Mezzanine bus, a PCI Express bus (and the like), a Universal Serial Bus (USB), a Secure Digital (SD) bus, and/or an IEEE 1394, i.e., FireWire bus.

Computer 802 may include a variety of computer readable media. Such media can be any available media that is accessible by computer 802 and includes both volatile and non-volatile media, removable and non-removable media.

System memory 806 includes computer readable media in the form of volatile memory, such as random access memory (RAM) 810; and/or non-volatile memory, such as read only memory (ROM) 812 or flash RAM. Basic input/output system (BIOS) 814, containing the basic routines that help to transfer information between elements within computer 802, such as during start-up, is stored in ROM 812 or flash RAM. RAM 810 typically contains data and/or program modules that are immediately accessible to and/or presently operated on by processing unit 804.

Computer 802 may also include other removable/non-removable, volatile/non-volatile computer storage media. By way of example, FIG. 8 illustrates hard disk drive 816 for reading from and writing to a non-removable, non-volatile magnetic media (not shown), magnetic disk drive 818 for reading from and writing to removable, non-volatile magnetic disk 820 (e.g., a “floppy disk”), and optical disk drive 822 for reading from and/or writing to a removable, non-volatile optical disk 824 such as a CD-ROM, DVD-ROM, or other optical media. Hard disk drive 816, magnetic disk drive 818, and optical disk drive 822 are each connected to system bus 808 by one or more data media interfaces 825. Alternatively, hard disk drive 816, magnetic disk drive 818, and optical disk drive 822 can be connected to the system bus 808 by one or more interfaces (not shown).

The disk drives and their associated computer-readable media provide non-volatile storage of computer readable instructions, data structures, program modules, and other data for computer 802. Although the example illustrates a hard disk 816, removable magnetic disk 820, and removable optical disk 824, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 816, magnetic disk 820, optical disk 824, ROM 812, and/or RAM 810, including by way of example, operating system 826, one or more application programs 828 (which can include genetic mapping as described above), other program modules 830, and program data 832. Each of such operating system 826, one or more application programs 828, other program modules 830, and program data 832 (or some combination thereof) may implement all or part of the resident components that support the distributed file system.

A user can enter commands and information into computer 802 via input devices such as keyboard 834 and a pointing device 836 (e.g., a “mouse”). Other input devices 838 (not shown specifically) may include a microphone, joystick, game pad, satellite dish, serial port, scanner, and/or the like. These and other input devices are connected to processing unit 804 via input/output interfaces 840 that are coupled to system bus 808, but may be connected by other interface and bus structures, such as a parallel port, game port, or a universal serial bus (USB).

Monitor 842 or other type of display device can also be connected to the system bus 808 via an interface, such as video adapter 844. In addition to monitor 842, other output peripheral devices can include components such as speakers (not shown) and printer 846 which can be connected to computer 802 via I/O interfaces 840.

Computer 802 can operate in a networked environment using logical connections to one or more remote computers, such as remote computing device 848. By way of example, remote computing device 848 can be a PC, portable computer, a server, a router, a network computer, a peer device or other common network node, and the like. Remote computing device 848 is illustrated as a portable computer that can include many or all of the elements and features described herein relative to computer 802. Alternatively, computer 802 can operate in a non-networked environment as well.

Logical connections between computer 802 and remote computer 848 are depicted as a local area network (LAN) 850 and a general wide area network (WAN) 852. Such networking environments are commonplace in offices, enterprise-wide computer networks, intranets, and the Internet.

When implemented in a LAN networking environment, computer 802 is connected to local network 850 via network interface or adapter 854. When implemented in a WAN networking environment, computer 802 typically includes modem 856 or other means for establishing communications over wide area network 852. Modem 856, which can be internal or external to computer 802, can be connected to system bus 808 via I/O interfaces 840 or other appropriate mechanisms. It is to be appreciated that the illustrated network connections are examples and that other means of establishing at least one communication link between computers 802 and 848 can be employed.

In a networked environment, such as that illustrated with computing environment 800, program modules depicted relative to computer 802, or portions thereof, may be stored in a remote memory storage device. By way of example, remote application programs 858 reside on a memory device of remote computer 848. For purposes of illustration, applications or programs and other executable program components such as the operating system are illustrated herein as discrete blocks, although it is recognized that such programs and components reside at various times in different storage components of computing device 802, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A computer-implemented method for cross-species comparative genomic hybridization visualization, the method comprising:
receiving a sequence of genetic information that is ordered in accordance with a first determined sequence of genetic material for a first species;
receiving an input command from a user for requesting a cross-species arrangement of data;
mapping the received genetic information in accordance with a second determined sequence of genetic material for a second species in response to the input command; and
outputting the mapped genetic information in accordance with the determined sequence of genetic material for the second species.

2. The method of claim 1 wherein the determined sequence of genetic material for the second species comprises gene sequences that have common synteny with the first species.

3. The method of claim 1 wherein the determined sequence of genetic material for the first species comprises selected genes that are present on a single chromosome and the determined sequence of genetic material from the second species comprises the selected genes that are present on a plurality of chromosomes.

4. The method of claim 1 further comprising mapping genetic information that is from a third species in accordance with one of the first and second determined sequences of genetic material.

5. The method of claim 1 wherein the received sequence of genetic information comprises numerical data from probes associated with a sequence of substantially contiguous genes from the first species wherein the numerical data exceed a first threshold.

6. The method of claim 5 wherein the received a sequence of genetic information comprises numerical data from probes associated with a sequence of substantially contiguous genes from the first species that is below a second threshold.

7. The method of claim 6 wherein the first and second thresholds are independently selectable.

8. The method of claim 1 wherein the received sequence of genetic information is selected in accordance with a selectable degree of conserved synteny between the first and second species.

9. The method of claim 1 further comprising outputting the received sequence of genetic information that is ordered in accordance with a determined sequence of genetic material for the first species.

10. A computer-implemented system for genetic mapping, the system comprising:
means for receiving a sequence of genetic information that is ordered in accordance with a first determined sequence of genetic material for a first species;
means for receiving an input command from a user for requesting a cross-species arrangement of data;
means for mapping the received genetic information in accordance with a second determined sequence of genetic material for a second species in response to the input command; and
means for outputting the mapped genetic information in accordance with the determined sequence of genetic material for the second species.

11. The system of claim 10 wherein the arrangement of selected genes of the second species comprises gene sequences that are substantially conserved from the first species.

12. The system of claim 10 wherein the arrangement of selected genes of a first species comprises selected genes that are present on a single chromosome and the selected genes are present on a plurality of chromosomes of the second species.

13. The system of claim 10 wherein the mapping means is further configured to rearrange a sequence of genes that is from a third species into a sequence of data that is associated with the arrangement of like genes of the second species.

14. The system of claim 10 wherein the data that are associated with the arrangement of selected genes of a first species comprise numerical data from probes associated with a sequence of substantially contiguous genes from the second species.

15. The system of claim 10 wherein the output mechanism displays the rearranged data in conjunction with an ideogram of the second species.

16. A computer-readable tangible medium containing instructions for cross-species comparative genomic hybridization, the medium comprising instructions for:
receiving an input command from a user for requesting a cross-species arrangement of data;
mapping the a stored sequence of genetic information that is ordered in accordance with a determined sequence of genetic material for a first species into a second determined sequence of genetic material in accordance with a second species in response to the input command; and
outputting the mapped genetic information in accordance the determined sequence of genetic material for the second species.

17. The medium of claim 16 further comprising instructions for mapping genetic information that is from a third species in accordance with a second determined sequence of genetic material for the second species.

18. The medium of claim 16 further comprising instructions for filtering numerical data from probes associated with a sequence of substantially contiguous genes from the first species and selecting numerical data that exceed a threshold.

19. The medium of claim 16 further comprising instructions for selecting the threshold.

20. The medium of claim 16 further comprising instructions for displaying the rearranged data in conjunction with an ideogram of the second species.
